(19) United States
(12) Patent Application Publication
(10) Pub. No.: US 2007/0240226 A1
(43) Pub. Date: Oct. 11, 2007

(54) Method and apparatus for user centric private data management

(75) Inventors: Yu Song, Pleasanton, CA (US); Anugeetha Kunjithapatham, Sunnyvale, CA (US); Alan Messer, Los Gatos, CA (US)

Correspondence Address: Kenneth L. Sherman, Esq.;Myers Dawers Andras & Sherman, LLP, 11th Floor, 19900 MacArthur Blvd., Irvine, CA, 92612, US

(73) Assignee: Samsung Electronics Co., Ltd., Suwon Ctiy (KR)

(21) Appl. No.: 11/391,745

(22) Filed: Mar. 28, 2006

(51) Int. Cl. H04L 9/32

(52) U.S. Cl. 726/27

(57) ABSTRACT

A data management method and system allows user centric, secured management and sharing of user information such as e-commerce data (including login details, credit card information etc.), policies and preferences set by a user in a networked home environment. A technique to encrypt and decrypt the user data is utilized, while physically storing the encrypted version of the data on a gateway device in the home rather than an online service/entity. It is in a user's best interest to manage the user's private information on the user side such that a user has absolute control over what, where the user's information flows.

### FIELD OF THE INVENTION

The present invention relates to data management, and in particular, to user centric private data management.

### BACKGROUND OF THE INVENTION

There are a number of advantages to maintaining structural “holes” in social networks, including controlling access of resources/information, and maintaining personal privacy. Because structural holes segment an individual's social network into unconnected network clusters, the individual is able to portray a socially appropriate facet of himself/herself to each cluster separately, without feeling constrained by the combined social norms. In order to continue to maintain separate social personas, the individual must also explicitly maintain the developed structural holes.

While the structural holes can be simply maintained in the physical world by association of physical environments with a particular cluster, this, however, does not directly translate to the digital world. In the digital world, it is relatively simple to switch “environments”. One can easily engage in two different chat-room conversations with individuals from distinctly different social circles. Although multiple windows give the impression of multiple “environments”, the ease with which people can rapidly switch between multiple “environments” results in numerous undesirable incidents. For example, it is not uncommon for individuals to mistakenly send an email or instant message to the wrong person.

A trend in the digital world is that increasing number of services are being provided online. Each of these services, however, requires service-specific user identification and authentication. For example, to access online service of Bank A, a user must create a unique id and password specifically for Bank A, and the user must create a separate id, password for Bank B if the user has an account with the bank and wants to access it online.

To combat the inconvenience of maintaining multiple accounts/different facet of online private data in digital worlds, several approaches have been suggested. One approach is the federal approach, such as Liberty Alliance. In the federal approach, agreements are established among service providers such that user accounts from different service providers are recognized across domains. This results a single, virtual identifier domain. When a user is authenticated to one service provider, the user is considered to be identified and authenticated with all service providers. Although the federation gives a user the illusion that there is one single identifier domain, a user, however, can still hold separate accounts for each service provider. One potential problem of this approach is that users still maintain multiple accounts even if they do not use them actively. Another problem is that this approach benefits service providers who may have more information about a user than a user intends them to have, and may use it against a user's desire of separation of social networks as discussed above.

Another approach uses a centralized user identity. This approach provides a single identifier and credential provider that is used for all service providers. A user can access all service providers using a single account. However, one problem with this approach is that there is a single point of failure where the account service holder (i.e., password service) can be the focus of security attack and thus, the identifier/credential service can be brought down. This results in the unavailability of other services that reply on the account information. Another problem is that if the security of this identifier/credential service provider is breached, all user information is leaked to perpetrator. Further, from a business point of view, service providers are tied to this account holder, resulting in service lock-in and monopoly.

Another approach recognizes the needs for managing multiple accounts on client side, and provides facilities to store account information on a local device. This approach eases the burden of multiple accounts maintenance. However, because these applications under this approach are designed to run on a single device (e.g., desktop PC), the accounts cannot be shared among multiple devices. Therefore, users must duplicate accounts on each device they use. In addition, the approach is application specific. For example, Mozilla password manager can only be used with Mozilla browser, not the Internet Explorer or other browsers. In OS X keychain's case, a user is the communication link between key chain and other applications. A user has to manually fetch the account identity and password and then cut-n-paste that information into another application.

Recognizing the need for user centric private data management, third-party companies began to provide account and private data management online. They allow users to store accounts on their web sites. The accounts can be retrieved in two ways. One way is automatic retrieval, wherein the company provides a small plugin in the user's browser. When installed, the plugin monitors the browsing URL. When the URL matches what is stored in the identity management database, it automatically fills the user name and password into the browser for the user. The second way is the manual retrieval, wherein if a URL is not recognized by the browser plugin, a user can request the user name and password by query the database. This approach, however, poses several disadvantages. The first obvious disadvantage is that even given a privacy policy statement, it is hard to convince users that their private information will not be misused. Second disadvantage is with the browser specific plugin, wherein to support a variety of applications (e.g., browsers) on different software and hardware platforms, the number of plugins and associated development costs will be skyrocketing.

### BRIEF SUMMARY OF THE INVENTION

In one embodiment the present invention provides a method and apparatus for user centric private data management. Such data management according to the present invention, provides management functionalities that facilitate secure management and sharing of user private data, such as login information, website preferences, credit card information and policies set in a networked home environment. This eases the burden of managing multiple identities and private data manually by a user and preserves the privacy of identities for different online/social networks, which is desired by users.

A data management method and system according to the present invention allows user centric, secured management and sharing of user information such as e-commerce data (including login details, credit card information etc.), policies and preferences set by a user in a networked home environment. A technique to encrypt and decrypt the user data is utilized, while physically storing the encrypted version of the data on a gateway device in the home rather than an online service/entity. It is in a user's best interest to manage the user's private information on the user side such that a user has absolute control over what, where the user's information flows.

These and other features, aspects and advantages of the present invention will become understood with reference to the following description, appended claims and accompanying figures.

### BRIEF DESCRIPTION OF THE DRAWINGS

FIG. 1 shows a functional block diagram of an example implementation of a data management system which implements a user centric private data management method in a home network, according to an embodiment of the present invention.

FIG. 2 shows an example flowchart of an embodiment of the steps of a data management method, according to an embodiment of the present invention.

FIG. 3 shows a functional block diagram of an example implementation of another data management in a network, according to another embodiment of the present invention.

### DETAILED DESCRIPTION OF THE INVENTION

In one embodiment the present invention provides a method and apparatus for user centric private data management. Such data management according to the present invention, provides management functionalities that facilitate secure management and sharing of user private data, such as login information, website preferences, credit card information and policies set in a networked home environment. This eases the burden of managing multiple identities and private data manually by a user and preserves the privacy of identities for different online/social networks, which is desired by users.

A data management method and system according to the present invention allows user centric, secured management and sharing of user information such as e-commerce data (including login details, credit card information etc.), policies and preferences set by a user in a networked home environment. A technique to encrypt and decrypt the user data is utilized, while physically storing the encrypted version of the data on a gateway device in the home rather than an online service/entity. It is in a user's best interest to manage the user's private information on the user side such that a user has absolute control over what and where the user's information flows.

Typically, there may be more than one desktop PC in a home, and there is a strong trend towards more devices with Internet connectivity at home. For example, a user can use a TV to perform online shopping, check email, etc. The multiplication of Internet-capable devices presents problems for a user. Each time a user wants to access an online service, the user needs to input the account information, such as user name/password. To perform online shopping requires the user to have the credit card information. This is tedious on multiple desktop PCs, and is almost unbearable on a TV because a TV does not have a convenient input method such as the keyboard for a PC. Moreover, the user could use a different device every time the user performs online shopping and the unavailability of a mechanism to store and share the login and credit card information the user possesses and entered earlier essentially causes the online shopping experience to be unpleasant for the user.

One way to solve this problem is to keep the private data in a removable media, such as SM card, memory stick, such that each time when the user uses a different device, the user would insert this media to the device. This, however, requires the user to carry the media all the time and it is no better than carrying credit cards directly. Worse than credit cards, if the media is lost, the user has no authority to report to. Another way would be to copy the information to every device in a home. However, updating information can be problematic since the user must update every device when information needs to be updated.

According to an embodiment of the present invention, the user information such as e-commerce data (including login details, credit card information, etc.), policies and preferences set by the user in a networked home environment, is stored in a central location that is always accessible. Unlike a corporate environment where workstations and servers are well managed, and servers are always online, devices in a home environment can be on and off at any time, except the home gateway. The home gateway is the only device in a home that needs to be online all the time for Internet connectivity.

The home gateway, however, can be insecure, because it is first in line in case of a security attack to the home. If the gateway is hacked, information on the gateway can be compromised. To combat potential security attacks, the private data needs to be encrypted when stored in the gateway, and decrypted during use by devices. One way to protect the data would be to let the gateway do the encryption and decryption. However, the encryption/decryption key(s) on the gateway are vulnerable.

Another way would be to let a device encrypt the information and store the encrypted data in the home gateway, and essentially turn the gateway into an always-accessible storage.

According to an embodiment of the present invention, the first time a device is installed in the home an ID (i.e., a secretive long sequence of characters) is assigned to the device. Then the user is prompted to enter a personal identification number (PIN). The combination of the assigned ID and the user PIN, is used to generate a key. This key is stored on the device and is used to encrypt any user private data that a user may enter through this device in the future. Then, the encrypted data is passed on to the gateway device in the home and the gateway manages this data thereafter, and serves a central database of user private data for the home.

The process of assigning an ID to a device, prompting the user to enter a PIN and generating a key based on the combination of the ID and the PIN, is repeated for every device installed in the home. Thus, every device in the home possesses a key at all times and is capable of encrypting data and decrypting encrypted data that it obtains from the gateway. When a user wishes to obtain the user's private data using a particular device, the corresponding device requests the gateway for the relevant data and decrypts the obtained encrypted data using the key the device possesses. Because the key for decrypting the encrypted user data is not stored on the gateway, even if the gateway is hacked or accessed without proper authorization, the user data stored thereon still cannot be decrypted by hackers.

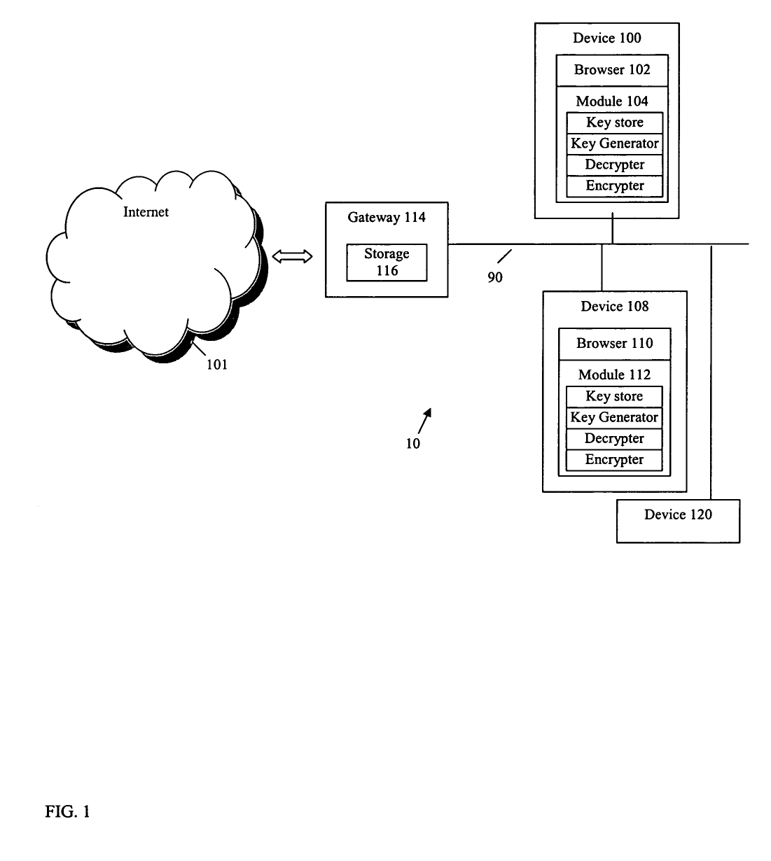

FIG. 1 shows a functional block diagram of an example implementation of a data management system 10 which implements a user centric private data management method in a local network 90 (e.g., a home network), according to an embodiment of the present invention. In this example, the system 10 includes devices 100, 108, gateway 114 and device 120, interconnected as shown.

In the home network 90, a user installs the device 100 and assigns an ID (a secretive long sequence of characters, e.g., 64 bytes) to the device 100. The user is prompted to enter the user's PIN and the device 100 generates an encryption key (e.g., symmetric key) based on the ID and the user's PIN. The device 100 stores the generated symmetric key on a security module 104 (e.g., plug-in software module) in the device 100. The symmetric key is randomly generated based on cryptographic standards, such as e.g. DES (Data Encryption Standard, Federal Information Processing Standards Publication 46-2, 1993, incorporated herein by reference). The security module 104 includes four submodules: a Key Store that contains the symmetric key safely; a Key Generator that generates the symmetric key; a Decrypter that decrypts the encrypted data with symmetric key; and an Encrypter that encrypts data with symmetric key.

The user then installs another device 108 and assigns an ID (same process as the one assigned for device 100). The user is prompted to enter the user's PIN and the device 108 generates a symmetric key based on the ID and the user's PIN, and stores the generated symmetric key on its security module 112 (e.g., plug-in software module). The security module 112 contains four submodules: a Key Store that contains the symmetric key safely; a Key Generator that generates the symmetric key, a Decrypter that decrypts the encrypted data with symmetric key; and an Encrypter that encrypts data with symmetric key.

The home gateway 114 is installed for Internet traffic. The device 100 includes an application 102 (e.g., Web browser) that is able to connect to the Internet 101 and allows the user to perform online activities. In order to invoke the security module 104, the device must authenticate the user through a PIN number. For example, if the device 100 is a TV, the user can use the TV remote control and input several digits (i.e., 6 digits) for the PIN number. As noted, PIN number is a secret number chosen by a user and is used to both identify the user and authenticate the user.

The device 108 is also capable of Internet activities using an application 110 (e.g., Web browser) that is able to connect to the Internet, and the security module 112. The browser 110 and the module 112 provide the same functionalities as the browser 102 and the module 104 for device 100. The gateway 114 includes a storage device 116 for storing data, including storing the personal private data of the user as described.

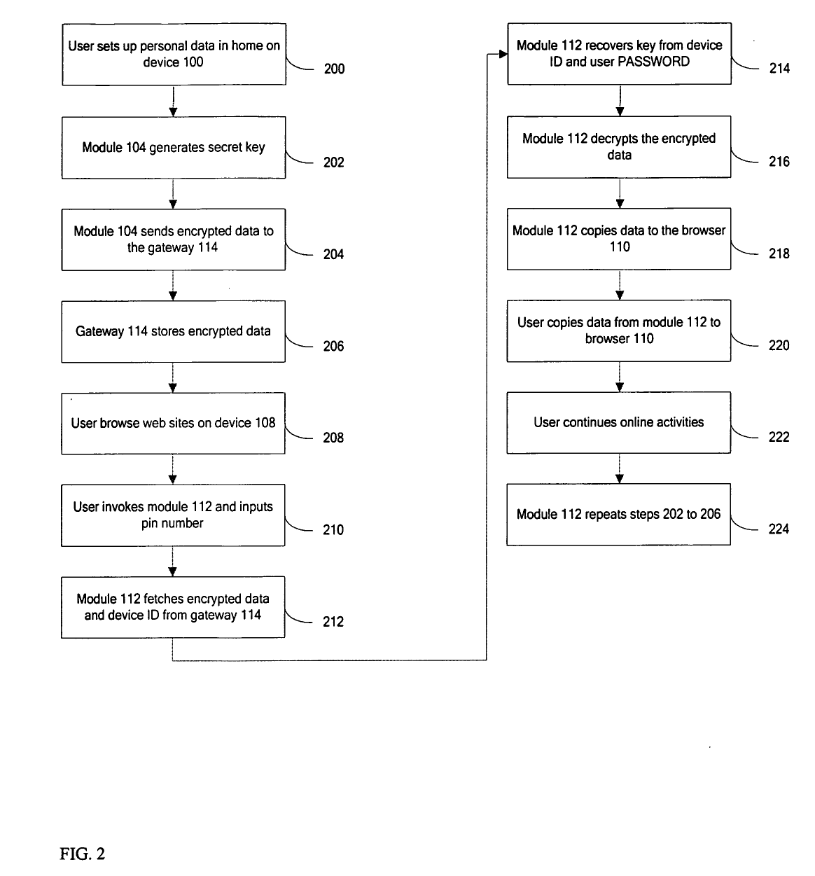

FIG. 2 provides an example flowchart of an embodiment of the steps of data management implemented by system 10, according to an embodiment of the present invention.

In step 200, the user uses the security module 104 as described to set up the user's personal information, such as credit card, address, telephone, email accounts, etc. into the security module 104 of device 100.

In step 202, the security module 104 asks the user for the user's personal PIN number, and generates a key. The user is allowed to continue only if the PIN is valid.

In step 204, the security module 104 uses the internally stored key to encrypt the data and send to gateway 114.

In step 206, the gateway 114 stores the data in the storage 116. The data is organized per user ID, such that different users have their own entries.

In step 208, at a later time, the user wants to access the Internet 101 through the device 108. The user utilizes the browser 110 to browse the Web and finds something the user wants to buy. Then he starts shopping via the browser 110 and eventually reaches the page that needs the user's credit card information.

In step 208 the security module 112 asks the user for the user's personal PIN number. The user is allowed to continue only if the PIN is valid.

In step 210, the user or an application invokes the security module 112 to fetch the relevant data (encrypted private data) from the gateway 114.

In step 212, the module 112 recovers key from device ID and user PASSWORD provided above.

In step 216, the security module 112 decrypts the encrypted data using the internally stored key.

In step 218, after decryption, the security module 112 looks up the input field names in the page displayed in the browser 110 and the name fields in the personal data. If there are unambiguous matches, the security module 112 copies the data from to the input form in the browser 110 automatically.

In step 220, there may be fields in the browser 110 that remain ambiguous. For example, a person is likely to own multiple credit cards, the security module 112 does not know what credit the user wants for the purchase. The user can manually select the appropriate data from the security module 112 and copy them into the browser 110.

In step 222, once the form in the browser 110 is filled, the user continues his online activities.

In step 224, thereafter module 112 repeats steps 202-206, if the user happens to enter some new data on the browser while performing online activities.

An alternative method of assigning the secret ID would be using public key infrastructure (PKI) for secret ID exchange. This requires another device 120 (FIG. 1) which must be online when a new device is brought into the network 100 and needs setup. It is assumed that each device contains a device public key and device private key.

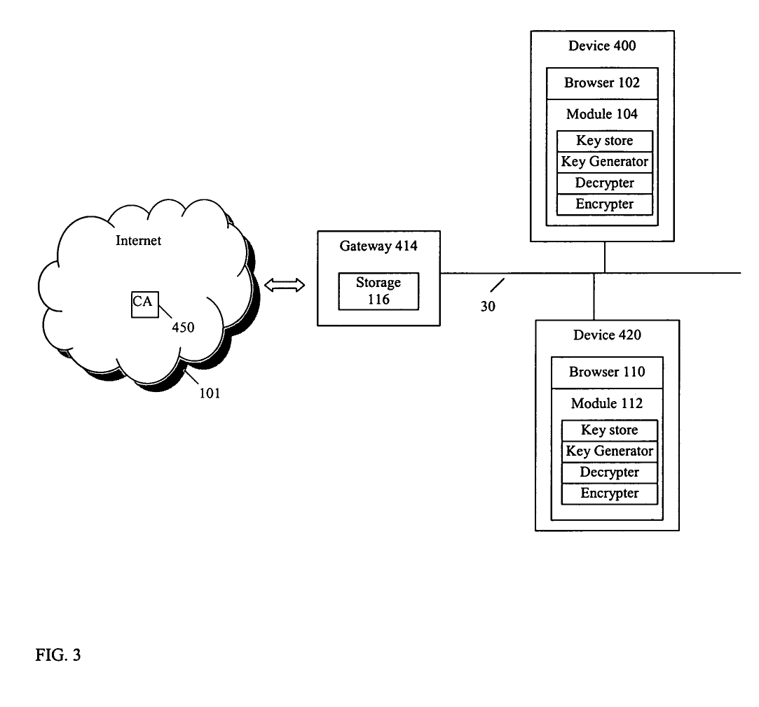

FIG. 3 shows a functional block diagram of an example implementation of another data management in a home network 30, according to another embodiment of the present invention. In this example, the system includes devices 400, 420 and gateway 414, interconnected as shown. The procedure of the ID sharing is as follows:
A user turns on an existing device 400. The device 400 already contains a secret ID for the home network 30.
The user turns on the new device 420, which searches other devices in the home network 30 (except the home gateway 414), and finds the device 400.
Device 420 asks device 400 for the secret ID using serial number of device 420.
Device 400 obtains a certificate for device 420 from a certificate authority (CA) 450 using serial number of device 420. The certificate contains the public key of device 420.
Device 400 encrypts the secret ID using public key of device 420, and signs it with its own private key.
Device 400 then sends a signed message (i.e., the message contains a digital signature of device 400, such as a private key of device 400), to device 420, wherein the message includes the encrypted secret ID, and the serial number of device 400.
Device 420 receives the signed message and serial number of device 400, and obtains a certificate from the CA 450 using serial number of device 420.
Device 420 then verifies the signed message using the public key in the obtained certificate for device 400.
Device 420 then decrypts the secret ID using its own private key and stores it safely in its safe storage area (e.g., in module 112 or another module in device 420).
This completes the step of device setup, and the device 420 is ready for data sharing.

According to yet another alternative embodiment of the present invention, the secret ID is assigned using an authenticated Diffie-Hellman key exchange method (W. Diffie, M E Hellman, “Privacy and Authentication: An Introduction to Cryptography”, Proc. of the IEEE, Vol. 67 No 3, pp 397-427, March 1979 (Dec. 2, 2000); and W. Diffie, P. C. van Oorschot, and M. J. Wiener, “Authentication and authenticated key exchanges”, Designs, Codes and Cryptography. Vol. 2 (1992), 107-125, incorporated herein by reference).

In this case, the secret ID is exchanged between a new device and an existing device by first generating a temporary symmetric key between the existing device and the new device. The temporary symmetric key is then used for exchange the secret ID. To protect the man-in-the-middle attack, the new and existing device must be authenticated with PKI before generating the temporary symmetric key.

Although an existing device must be involved for the above-mentioned alternative methods, that requirement is reasonable because the setup process is generally performed in a home network where other existing devices are easily accessible.

Accordingly, the present invention adopts a user centric approach for private data management and sharing. It is in a user's best interest to manage the user's private information on the user side such that a user has absolute control over what and where the user's information flows. This is advantageous to conventional approaches in the digital world where communication entities cannot afford the assumption of trust.

In comparison with the federal approach, the present invention maintains the separation of digital/social networks at a user's command such that service providers cannot intentionally and/or un-intentionally link one account with another account. Further, unlike the centralized approach, the present invention allows freedom for service providers in providing their authentication and authorization models and implementation without business and technology lock-in. It is also beneficial to the users as they do not have to lock-in with a particular accounts management provider. The present invention expands the approach of application specific password management to multiple devices in a home network. This is especially important for emerging home networks and networked devices where each device can access resources and services online independently. In addition, the present invention does not require each device to store user information locally, since consumer electronic devices may not have local storage capability.

While the present invention is susceptible of embodiments in many different forms, these are shown in the drawings and herein described in detail, preferred embodiments of the invention with the understanding that this description is to be considered as an exemplification of the principles of the invention and is not intended to limit the broad aspects of the invention to the embodiments illustrated. The aforementioned example architectures above according to the present invention can be implemented in many ways, such as program instructions for execution by a processor, as logic circuits, as ASIC, as firmware, etc., as is known to those skilled in the art. Therefore, the present invention is not limited to the example embodiments described herein.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method for user data management of networked devices, comprising the step of:
receiving user data via a device;
encrypting the user data using a key;
storing the encrypted user data in a designated device accessible by a plurality of devices;
whereby the user manages said user data such that the user has control over dissemination of the user data.

2. The method of claim 1 wherein the user data comprises one or more of e-commerce data, policies and preferences.

3. The method of claim 1 wherein the designated device comprises an essentially always available device.

4. The method of claim 3 wherein the designated device comprises a gateway device in a local network.

5. The method of claim 1 further comprising the steps of:
upon need to access the stored encrypted user data, accessing the stored encrypted user data in the central device, and performing decryption of the encrypted user data using said key.

6. The method of claim 1 wherein the steps of encrypting the user data further comprises the steps of performing encryption of the user data in a user device.

7. The method of claim 6 further comprising the steps of transmitting the encrypted user data to the designated device for storage therein such that encrypted user data is available to the user devices.

8. A method for user data management, comprising the step of:
installing a user device in the local network by:
generating an encryption key;
storing the key in the user device for use to encrypt any user data that the user may enter through the user device;
providing user data to the user device;
performing encryption on the user data using the key stored in the user device; and
transmitting the encrypted data for storage in a designated device accessible by a plurality of devices.

9. The method of claim 8 further comprising the steps of:
upon need to access the stored encrypted user data, accessing the stored encrypted user data in the designated device via said user device, and performing decryption of the encrypted user data using the key stored in the user device.

10. The method of claim 8 wherein the user data comprises one or more of e-commerce data, policies and preferences.

11. The method of claim 8 wherein the central device comprises an essentially always available device.

12. The method of claim 11 wherein the designated device comprises a gateway device in the local network.

13. The method of claim 8 wherein the steps of generating the encryption key further includes the steps of:
assigning an ID to the user device;
receiving a PIN from a user;
generating the encryption key based on the user device ID and the user PIN.

14. The method of claim 13 wherein the steps of assigning the ID further comprises the steps of using a public key infrastructure (PKI) for secret ID exchange, wherein the user device includes a device public key and device private key.

15. The method of claim 13 wherein the steps of assigning the ID further comprises the steps of assigning the ID using an authenticated Diffie-Hellman key exchange method.

16. A user data management system of connected devices, comprising:
a security module that receives user data via a device, and encrypts the user data using a corresponding encryption key, wherein each of a plurality of devices includes a corresponding encryption key;
wherein the security module stores the encrypted user data in a designated device accessible by a plurality of devices, such that the user manages said user data such that the user has control over dissemination of the user data.

17. The system of claim 16 further comprising a database in the designated device for storing encrypted user data from one or more user devices.

18. The system of claim 16 wherein the designated device comprises an essentially always available device.

19. The system of claim 18 wherein the central device comprises a gateway device in the local network.

20. The system of claim 16 wherein upon need to access the stored encrypted user data, the security module further accessing the stored encrypted user data in the central device, and performs decryption of the encrypted user data using said key.

21. The system of claim 16 wherein the security module is a component of said user device receiving user data.

22. The system of claim 21 wherein the user device transmits the encrypted user data to the designated device for storage therein such that encrypted user data is available to the user devices.

23. The system of claim 1 further comprising a plurality of security modules, each security module associates with a corresponding one of the plurality of user devices, wherein each of the plurality of devices includes a corresponding encryption key.
